(19) United States
(12) Patent Application Publication
(10) Pub. No.: US 2004/0182989 A1
(43) Pub. Date: Sep. 23, 2004

(54) Flexible mould with air circulation

(76) Inventor: Herve De Buyer, Faymont (FR)

Correspondence Address: Gregory J. Lavorgna, DRINKER BIDDLE & REATH LLP, One Logan Square, 18th & Cherry Streets, Philadelphia, PA, 19103-6996, US

(21) Appl. No.: 10/449,932

(22) Filed: May 29, 2003

(30) Foreign Application Priority Data
Mar. 19, 2003 (FR) 03 03 382

(51) Int. Cl. A21B 3/13

(52) U.S. Cl. 249/127

(57) ABSTRACT

Flexible mould intended for the food industry, particularly for baking savoury and sweet pastry and food items, capable of resisting a very wide range of temperatures from approximately −70° C. to +300° C. and manufactured by moulding following the use of hot- or cold-cure silicones, and preferably polymethylsiloxane with a high molecular weight curing at approximately 150 to 160° C., this mould being constituted by a moulding tray (1) provided with moulding cells (2) uniformly distributed over one of its faces or first face and projecting on its other face or second face.

The moulding tray (1) is provided with a set of air circulation holes (3) uniformly distributed between the cells (2) over the totality of its surface.

The present invention relates to a flexible mould intended for the food industry, particularly for baking savoury and sweet pastry and food items, capable of resisting a very wide range of temperatures from approximately −70° C. to +300° C.

The moulds of the aforementioned type have for a long time been manufactured from metal (steel or aluminium); the application of a film of greasy substance (oil or butter) on the internal wall thereof did not prevent the users from encountering, during demoulding. problems of adhesion and of sticking which are prejudicial in particular to the appearance of the end product.

Furthermore, cleaning of the moulds thus soiled was always lengthy and inconvenient and frequently necessitated scraping operations which encourage sticking and end eventually in damage to the mould and therefore to a shortening of the service life thereof.

In order to solve these problems, it has been proposed to apply non-stick coatings, particularly of polytetrafluoroethylene or silicones, to the internal walls of the metal moulds; in spite of certain advantages, such an application has not proved totally satisfactory, particularly because of the fragility of the non-stick coatings and their high sensitivity to abrasion, the consequence of which is that they very quickly become unusable.

Furthermore, the use of the non-stick coatings does not enable the problems encountered by users during demoulding to be solved, taking into account the rigidity of metal moulds: in fact it is often necessary, in order to extract the baked product, to knock the base or the side walls of the mould, even to pass the blade of a knife between the mould and the product.

In order to remedy these drawbacks, there has already been proposed in accordance with the document FR-2 747 886 a flexible mould manufactured by moulding following the use of hot- or cold-cure silicones, and preferably polymethylsiloxane with a high molecular weight curing at approximately 150 to 160° C.

This mould, which is capable of resisting a very wide range of temperatures from approximately −70° C. to +300° C. has, in addition to its non-stick feature, numerous advantages when it is used for the manufacture of single articles for baking with relatively large dimensions (mould for sponge cake, fruit cake, brioche, savarin, . . . ). In fact it has a mean thickness of the order of 1.5 to 2.5 mm, which gives it a very high degree of flexibility and a great facility for deformation; furthermore, the implementation of a moulding process makes it possible to obtain surfaces which are extremely smooth and therefore highly non-stick, which avoids any risk of sticking of the cooked product on the walls of the mould and thus permits easy demoulding.

Another advantage of such manufacture by moulding is linked to the fact that is permits all the shapes of metal moulds which exist today to be reproduced, including the most complicated ones and even those with sharp angles and in particular right angles.

However, it should be noted that alongside single moulds of the aforementioned type, professional pastrycooks just like amateur cooks frequently use moulding trays provided with cells uniformly distributed over their surface in such a way as to produce in one single “batch” a series of biscuits or cakes of smaller dimensions (mould for madeleines, financiers, . . . ).

Thus the principle of the known flexible moulds based on silicones has been adapted to moulds constituted by a moulding tray provided with moulding cells uniformly distributed over one of its faces or first face and projecting on its other face or second face.

However, such an adaptation has not been entirely satisfactory bearing in mind in particular the fact that during cooking the air stagnates between the moulding cells on the second face of the mould and therefore does not circulate sufficiently, seriously spoiling the end product in terms of both appearance and taste.

The object of the invention is to remedy this drawback by proposing a flexible mould of the aforementioned type with circulation of hot or cold air.

According to the invention such a mould is characterised in that the moulding tray is provided with a set of air circulation holes uniformly distributed between the cells, over the totality of its surface.

Thus the hot air which tends to be displaced upwards can pass through the moulding openings in order to be permanently replenished and can come to “bathe” the whole of the moulding tray and permit rapid and regular cooking.

It should be noted that the field of use of the flexible mould according to the invention is not limited to the cooking of foodstuffs, but that this mould is equally adapted to the refrigeration of such products, in which case the circulation of cold air through the air circulation holes takes place easily not only upwards from below but also downwards from above.

As a general rule the moulding tray is equipped with a series of moulding cells distributed geometrically over its surface, particularly in rows which are for example parallel.

In this configuration the moulding tray is equipped with a series of air circulation holes distributed geometrically around the moulding cells, particularly in rows which are for example parallel situated between the rows of moulding cells.

In this latter case the air circulation holes are as a rule disposed in staggered rows with respect to the moulding cells.

In other words, in such a configuration an air circulation hole is pierced through each of the areas separating the adjacent moulding cells.

Naturally the moulding cells and the air circulation holes can be of any geometry without in any way departing from the scope of the invention and in any case this depends upon the geometry of the moulding tray (rectangular, circular, polygonal . . . ).

In order to be completely satisfactory, it is necessary for the air circulation holes to have sufficient dimensions to allow good aeration or ventilation of the two faces of the moulding tray, whilst at the same time adapted so as to guarantee good performance of the tray.

According to the invention, it was possible to meet this dual requirement by virtue of the air circulation holes of essentially circular shape, having a diameter of between approximately 0.2 and 2.0 cm.

Here, too, the air circulation holes can be of any shape and dimensions without in any way departing from the scope of the invention, and this depends upon the geometry of the moulding tray and the type of product to be handled.

In spite of an adapted choice of dimensions of the air circulation holes, the moulding trays have a very high degree of flexibility which involves difficulties of handling both when being put into or removed from the oven and when being demoulded.

In order to remedy this drawback and to increase the rigidity of the earlier moulds mentioned above as described in the patent FR-2 747 886, in accordance with FR-2 786 668 there has already been proposed a moulding tray in which the moulding cells are connected over the second face of the tray by stiffening ribs which are distributed geometrically, particularly parallel stiffening ribs extending in two perpendicular directions in such a way as to define stiffening mouldings of rectangular shape situated in each of the areas separating the adjacent moulding cells.

The invention is more especially adapted to moulding trays of this type in which the stiffening mouldings are equipped with an air circulation hole pierced in their central portion.

The stiffening ribs can of course be non-existent if their presence is not justified.

In conclusion, the air circulation holes which are provided in the flexible mould which is the subject of the present invention make it possible to guarantee the ventilation of this mould during heating or cooling in order to obtain a regular temperature around the cells which receive the product in preparation.

The characteristics of the flexible mould which is the subject of the invention will be described in greater detail with reference to the accompanying non-limiting drawings in which:

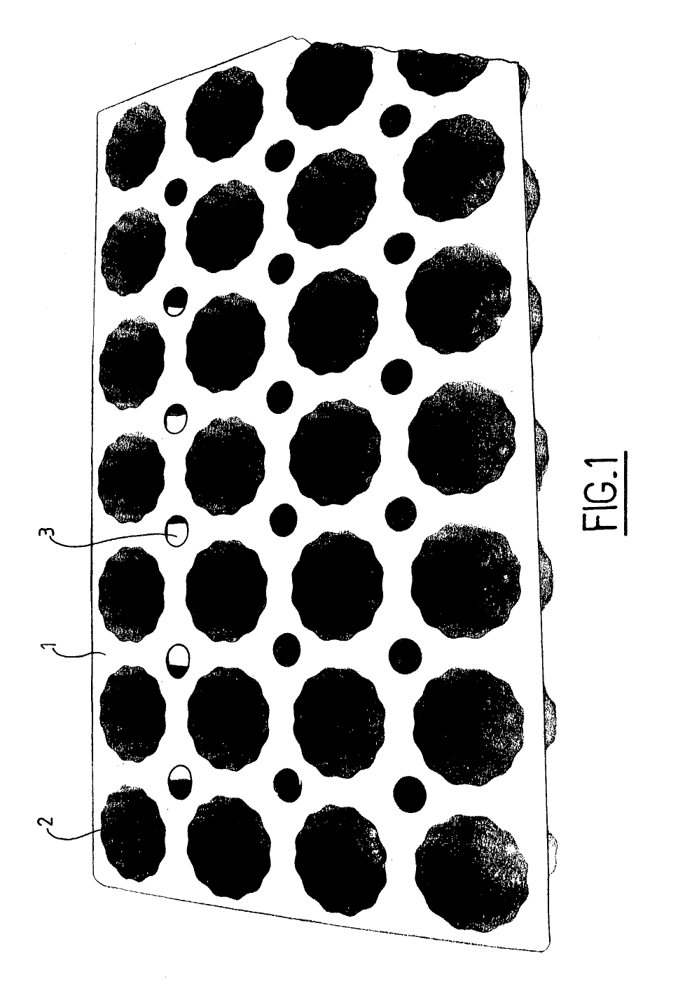

FIG. 1 shows the first face of the flexible mould;

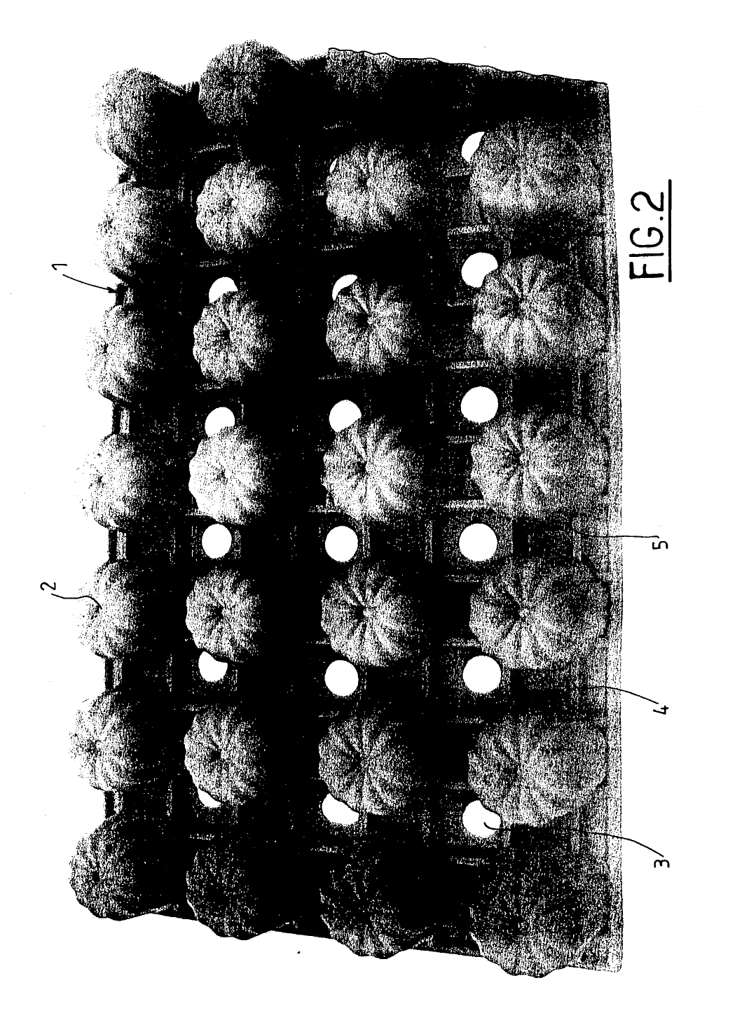

FIG. 2 shows the second face of this same mould.

According to FIG. 1 the flexible mould is formed by a tray 1 made from silicone equipped with moulding cells 2 distributed in parallel rows over all of the surface thereof.

According to FIG. 2, the moulding cells 2 project on the second face of the moulding tray.

According to FIGS. 1 and 2, the tray is also equipped with a set of air circulation holes 3 of essentially circular shape uniformly distributed between the moulding cells 2.

The air circulation holes 3 themselves are also distributed in parallel rows. These rows are situated between the rows of moulding cells 2.

The moulding cells 2 and the air circulation holes 3 are disposed in staggered rows, in such a way that an air circulation hole 3 is pierced in each area separating four adjacent moulding cells 2.

According to FIG. 2, the moulding cells 2 are connected on the second face of the moulding tray 1 by parallel stiffening ribs 4 extending in two perpendicular directions.

These stiffening ribs 4 define stiffening mouldings 5 of square shape which are situated in each of the areas separating four adjacent moulding cells 2.

The stiffening mouldings 5 are each provided with an air circulation hole pierced in the central part thereof.

1. Flexible mould intended for the food industry, particularly for baking savoury and sweet pastry and food items, capable of resisting a very wide range of temperatures from approximately −70° C. to +300° C. and manufactured by moulding following the use of hot- or cold-cure silicones, and preferably polymethylsiloxane with a high molecular weight curing at approximately 150 to 160° C., this mould being constituted by a moulding tray (1) provided with moulding cells (2) uniformly distributed over one of its faces or first face and projecting on its other face or second face, characterised in that the moulding tray (1) is provided with a set of air circulation holes (3) uniformly distributed between the cells (2) over the totality of its surface.

2. Flexible mould as claimed in claim 1, constituted by a moulding tray (1) equipped with a series of moulding cells (2) distributed geometrically over its surface, particularly in rows which are for example parallel, characterised in that the moulding tray (1) is equipped with a series of air circulation holes (3) distributed geometrically around the moulding cells, particularly in rows which are for example parallel situated between the rows of moulding cells (2).

3. Flexible mould as claimed in claim 2, characterised in that the air circulation holes (3) are disposed in staggered rows with respect to the moulding cells (2).

4. Flexible mould as claimed in any one of claims 1 to 3, characterised in that the air circulation holes (3) are of essentially circular shape and have a diameter of between approximately 0.2 and 2.0 cm.

5. Flexible mould as claimed in any one of claims 1 to 4, in which the moulding cells (2) are connected over the second face of the moulding tray (1) by stiffening ribs (4) which are distributed geometrically, particularly parallel stiffening ribs extending in two perpendicular directions in such a way as to define stiffening mouldings (5) of rectangular shape situated in each of the areas separating the adjacent moulding cells (2), characterised in that the air circulation holes (3) are pierced between the stiffening ribs (4).

6. Flexible mould as claimed in claim 5, characterised in that the stiffening mouldings (5) are equipped with an air circulation hole pierced in the central part thereof.
